(19) United States
(12) Patent Application Publication
(10) Pub. No.: US 2013/0049370 A1
(43) Pub. Date: Feb. 28, 2013

(54) In-Line Water Generator

(71) Applicant: Jeffrey Koesterich, Teaneck, NJ (US)

(72) Inventor: Jeffrey Koesterich, Teaneck, NJ (US)

(21) Appl. No.: 13/494,221

(22) Filed: Jun. 12, 2012

Related U.S. Application Data
(60) Provisional application No. 61/527,297, filed on Aug. 25, 2011.

(51) Int. Cl. F03B 13/00

(52) U.S. Cl. 290/54

(57) ABSTRACT

An architecture is presented that provides an in-line generator device designed primarily as a low-cost alternative to producing electrical power, generated through conduits. The in-line generator device comprises a housing unit, wherein the housing unit is secured to a conduit on both the first end and the second end, creating a passage. The in-line generator device further comprises at least one wheel encased in the housing unit that rotates with the passing of an amount of pressurized fluid. Additionally, a drive shaft is secured to the center of rotation of the wheel, and protrudes out through an air tight/water tight seal from the wheel to communicate with a generator. Rotation of the wheel via the flow of fluid through the housing unit, causes rotation of the drive shaft which communicates with the generator to generate electricity.

### CROSS-REFERENCE

This application claims priority from Provisional Patent Application Ser. No. 61/527,297 filed Aug. 25, 2011.

### BACKGROUND

As the cost of electricity continues to rise, companies and individuals continue to look for new ways to produce power or harness existing energy. Various generators are already in the market, and new generators are constantly being designed and constructed as low-cost alternatives to producing electricity. However, while these generators may utilize wind, water, or other natural resources, the generators are typically large, unwieldy, and very costly to produce upfront. Additionally, as building owners and homeowners already pay for the use of water and gas, a generator that utilizes water or gas, or other fluids to produce electricity would be useful. An effective solution for this problem is necessary.

There is a need for an improved generator that is designed to utilize water to produce electricity, and that is compact and easy to install and/or use. The present invention discloses an in-line generator device that is a small connector device that can be affixed to water pipes, drainage pipes, hybrid automobiles' water pump cooling systems, gas and propane lines, municipalities' water mains, and pool filtration systems to produce electrical power. This device can utilize any incoming water supply via pipes or other conduits. When the water is turned on for use, the flow of water can turn a wheel in the device, which can turn a generator, which will generate electricity. The produced electricity can either be used directly as its created, or it can be grid-based to be sold back to the power company.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an in-line generator device designed primarily as a low-cost alternative or supplement to existing sources which produces electrical power, generated through conduits. The in-line generator device comprises a housing unit, wherein the housing unit is secured to a conduit on both the first end and the second end, creating a fluid passage. Furthermore, the first end of the housing comprises an inlet connection and the second end of the housing comprises an outlet connection for attaching the in-line generator device to the conduit. The in-line generator device further comprises at least one wheel encased in the housing unit that rotates with the passing of an amount of fluid. Additionally, a drive shaft is secured to the center of rotation of the wheel, and protrudes out through a water tight seal from the wheel to communicate with a generator. Rotation of the wheel via the flow of water through the housing unit, causes rotation of the drive shaft which communicates with the generator to generate electricity.

Furthermore in the preferred embodiment of the present invention, the electricity that is produced from the generator can be converted into another form of power via an inverter. The converted electricity can then be used directly as its created, or it can be grid-based and sold back to the power company. Any additional or excess electricity that is produced can also be stored in a battery for future use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of an in-line generator device in accordance with the disclosed architecture.

FIG. 2 illustrates a perspective view of the in-line generator device showing how a fluid would flow through the device in accordance with the disclosed architecture.

FIG. 3 illustrates a perspective view of the in-line generator device showing how a gas would flow through the device in accordance with the disclosed architecture.

FIG. 4 illustrates a perspective view of the in-line generator device in use and affixed to pipes and gas lines in accordance with the disclosed architecture.

FIG. 5 illustrates a perspective view of the in-line generator device in use and affixed to a drainage pipe in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses an in-line generator device that is a relatively small connector device that can be attached in an inline manner to water pipes, drainage pipes, hybrid automobiles' water pump cooling systems, gas and propane lines, pool filtration systems, and municipalities' water mains, to produce electrical power. The in-line generator device comprises a housing unit secured to a conduit on both the first end and the second end, creating a fluid passage. The in-line generator device further comprises at least one wheel encased in the housing unit that rotates with the passing of an amount of fluid or gas, as the case may be. Additionally, a drive shaft is secured to the center of rotation of the wheel, and protrudes out through an airtight/watertight seal from the wheel to communicate with a generator. Rotation of the wheel via the flow of water and or gas through the housing unit, causes rotation of the drive shaft which communicates with the generator to generate electricity.

Thus, this device can utilize any incoming water or gas supply via pipes or other conduits. When the water or gas is turned on for use, the flow of the water or gas, as the case may be, will cause the wheel to rotate within the device, which can generate electricity. Specifically, the device will start producing electricity with a slow flow of water or gas, and will continue to produce electricity (at a faster rate) as the flow of water or gas gets faster. The produced electricity can either be used directly as its created, or it can be grid-based to be sold back to the power company. The in-line generator device can be used as a low-cost alternative to producing electrical power, generated through fluid or gas conduits, or as a supplement to existing sources. Users will appreciate the convenience and efficiency that this invention affords.

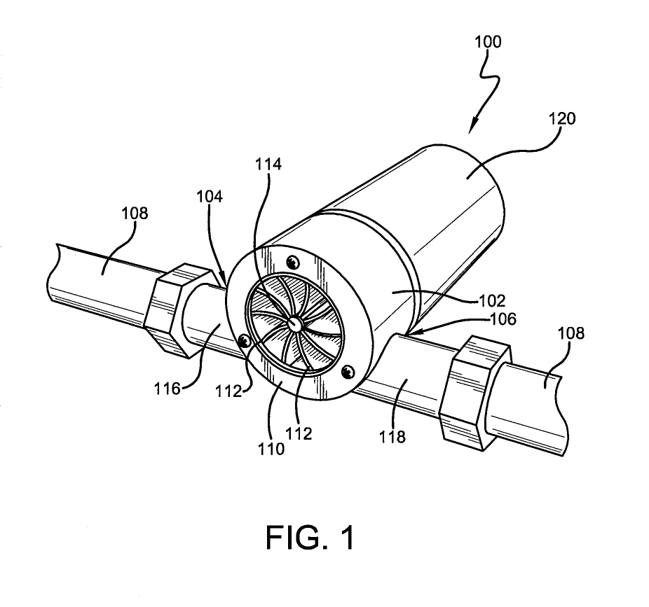

Referring initially to the drawings, FIG. 1 illustrates an in-line generator device 100 designed primarily as a low-cost alternative to producing electrical power, or as a supplement to existing sources, generated through fluid or gas pipes. The in-line generator device (or generating device) 100 comprises a housing unit 102 comprising a first end 104 and a second end 106, wherein the housing unit 102 is secured to a section of conduit 108 on both the first end 104 and the second end 106, thereby creating an inline passage, as illustrated in FIG. 1. Typically, the housing unit 102 is cylindrical in shape, however any other suitable shape can be used as is known in the art without affecting the overall concept of the invention. The housing unit 102 would generally be constructed of metal or plastic, such as polycarbonate, acrylonitrile butadiene styrene (ABS) or polyvinyl chloride (PVC), though any other suitable material may be used to manufacture the housing unit 102 as is known in the art without affecting the overall concept of the invention.

The housing unit 102 is approximately between 2 and 3 inches wide as measured from first end 104 to second end 106, and approximately between 4 and 5 inches in the inside diameter, with the outside diameter being slightly larger than the inside diameter. However, the housing unit 102 will vary in size, depending on the size of the conduit it is attached to. Furthermore, the inlet connection 116 and the outlet connection 118, as well as the paddles 112, need to have the same or greater inside diameter (i.e., dimensions) as the supply conduit. For example, if the housing unit 102 is connected to a ¾ inch pipe, the housing 102 can be approximately 2 inches wide. If however, the housing unit 102 is connected to an 18 inch water main, the housing unit 102 can be approximately 38 inches wide. Thus, the outside size of the housing unit 102 will depend on, and will vary based on the inside diameter of the conduit being employed. Also, the generator 120 can be of a larger or smaller size than the housing unit 102.

The conduit 108 has the appearance of a typically constructed conduit as is known in the art, and can comprise pressurized pipes and hoses, such that the in-line generator device 100 can operate via liquids (e.g., water), gases (e.g., propane or natural gas), or steam. Furthermore, the first end 104 of the housing 102 comprises an inlet connection 116 and the second end 106 of the housing 102 comprises an outlet connection 118 for attaching the in-line generator device 100 to the conduit 108. Specifically, the inlet connection 116 and outlet connection 118 are typically secured to the conduit 108 to form the passage via hose clamps, compression clamps, soldering, etc., or any other suitable securing means as is known in the art for connecting pipes or conduit. Thus, the in-line generator device 100 can be easily installed along existing plumbing or drainage pipes of a building, hybrid automobile water pump cooling systems, gas and propane lines, pool filtration systems, and municipalities water mains, or any other incoming fluid supply via pressurized pipes and hoses as is known in the art, such that when the fluid is turned on for use, the flow of the fluid through the passage can be harnessed to generate electricity. Furthermore, the in-line generator device is typically attached to the main water line or gas line as it enters the building, thus fluid flow anywhere in the building would activate the generator. However, multiple in-line generator devices could also be installed at individual branches as well, depending on the wants and needs of the user.

Additionally, the inlet connection 116 and the outlet connection 118 are placed in a straight line or a series, such that fluid will enter the housing unit 102 through the inlet connection 116, pass through the housing unit 102, and then exit through the outlet connection 118. However, the inlet and outlet connections 116 and 118 do not have to be positioned in a straight line and can operate even if not positioned in a straight line. Thus, the inlet connection 116 allows fluid to enter the housing unit 102, and the outlet connection 118 allows the fluid to exit the housing unit 102.

The in-line generator device 100 further comprises at least one wheel 110 secured to the interior of the housing unit 102, and encased in the housing unit 102. The wheel 110 has the appearance of a typically constructed wheel 110 as is known in the art, and rotates with the passing of an amount of fluid. The wheel 110 comprises a rotational center portion 114 and paddles (or vane members) 112 of which the inner end portions are connected to the rotational center portion 114. The paddles 112 are curved at a midway portion so as to readily receive fluid from the conduit 108. Therefore, the fluid that enters the housing unit 102 through the inlet connection 116, contacts the paddles 112 of the wheel 110 rotating the wheel 110, passes through the housing unit 102, and then expels out the outlet connection 118 of the housing unit 102. Thus, the wheel 110 is positioned at the passage created by the housing unit 102 and rotates with passing of the fluid over the paddles 112 of the wheel 110. Additionally, the wheel 110 is positioned tightly (or snugly) within the interior of the housing unit 102, such that the fluid is forced to pass through the bottom of the paddles 112 of the wheel 110. Furthermore, additional wheels 110 may be added to the housing unit 102 depending on the needs and desires of the user to create more spin, resulting in the production of more electricity.

Additionally, a drive shaft (not shown) is secured to the wheel 110. Specifically, the drive shaft is secured to the center of rotation of the wheel 110 and protrudes out through an air tight/water tight seal from the wheel to communicate with a generator 120. The drive shaft is typically formed integrally with the wheel 110 and coaxial with the wheel 110. Therefore, as soon as the wheel 110 rotates via the fluid power, the drive shaft rotates integrally with the wheel 110. However, the drive shaft can also be a separate device from the wheel 110. If the drive shaft is a separate device, it is then secured to the wheel 110 via pressed fit, keyed fit, etc. or any other suitable fasteners as is known in the art. Furthermore, the generator 120 is positioned in communication with the drive shaft for generating electricity.

The generator 120 has the appearance of a typically constructed generator 120 as is known in the art, and operates to produce an induced voltage based on the flow of magnetic fluxes produced via the rotating drive shaft and wheel 110. For example, the generator 120 can comprise a permanent magnetic alternator (PMA), low RPM permanent magnetic alternators, etc., or other suitable generators that operate via a spinning motion as is known in the art without affecting the overall concept of the invention. The induced voltage that is produced can be converted into another form of power via an inverter (not shown). The inverter has the appearance of a typically constructed inverter as is known in the art. The converted voltage can then be used directly as its created, or it can be grid-based and sold back to the power company. Any additional or excess electricity that is produced can also be stored in a battery (not shown) for future use. The battery has the appearance of a typically constructed battery as is known in the art, such as an automotive battery.

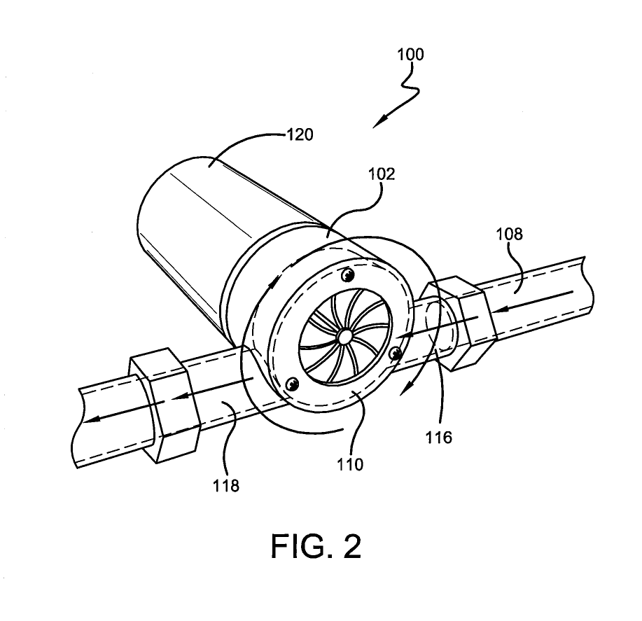

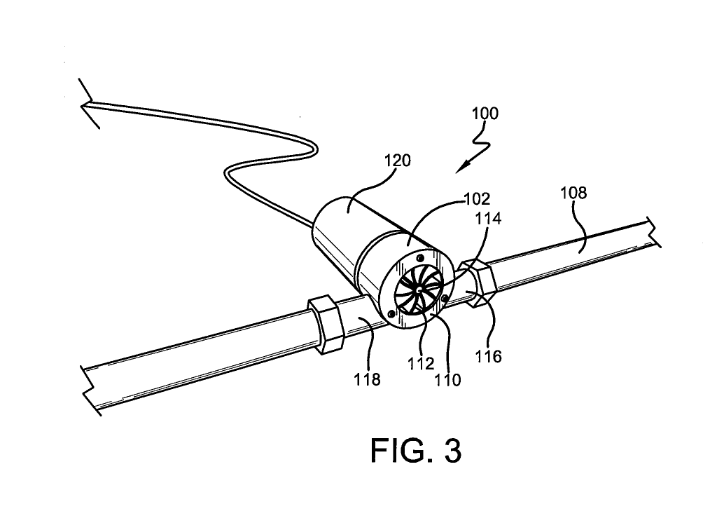

FIGS. 2-3 illustrate the in-line generator device 100 showing how a fluid would flow through the device 100 from a conduit 108. Typically, the inlet connection 116 and the outlet connection 118 are placed in a straight line (as shown in FIGS. 2-3), such that fluid will enter the housing unit 102 through the inlet connection 116, pass through the housing unit 102, and then exit through the outlet connection 118. Furthermore, a wheel 110 is encased in the housing unit 102 of the in-line generator device 100 and rotates with the passing of an amount of fluid. The wheel 110 comprises a rotational center portion 114 and paddles (or vane members) 112 of which the inner end portions are connected to the rotational center portion 114.

Therefore, the fluid that enters the housing unit 102 through the inlet connection 116 from the conduit 108, contacts the paddles 112 of the wheel 110 rotating the wheel 110, passes through the housing unit 102, and then expels out the outlet connection 118 of the housing unit 102. Thus, the wheel 110 is positioned at the fluid passage created by the housing unit 102 and rotates with passing of the fluid over the paddles 112 of the wheel 110. Additionally, the wheel 110 is positioned tightly (or snugly) within the interior of the housing unit 102, such that fluid is forced to pass through the bottom of the paddles 112 of the wheel 110.

Additionally, a drive shaft is secured to the center of rotation of the wheel 110, and protrudes out through an air tight/water tight seal from the wheel to communicate with a generator 120. The drive shaft is typically formed integrally with the wheel 110 and coaxial with the wheel 110. Therefore, as soon as the wheel 110 rotates via the fluid power, the drive shaft rotates integrally with the wheel 110 and communicates with the generator to generate electricity.

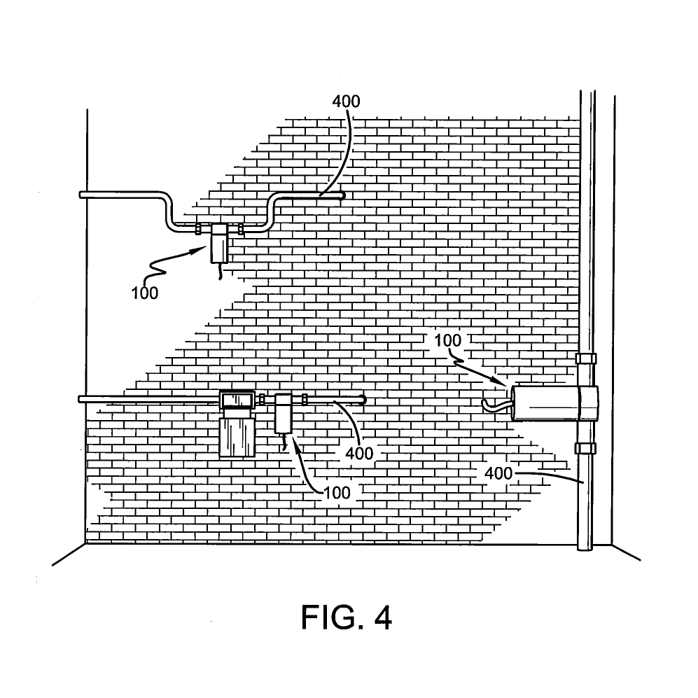

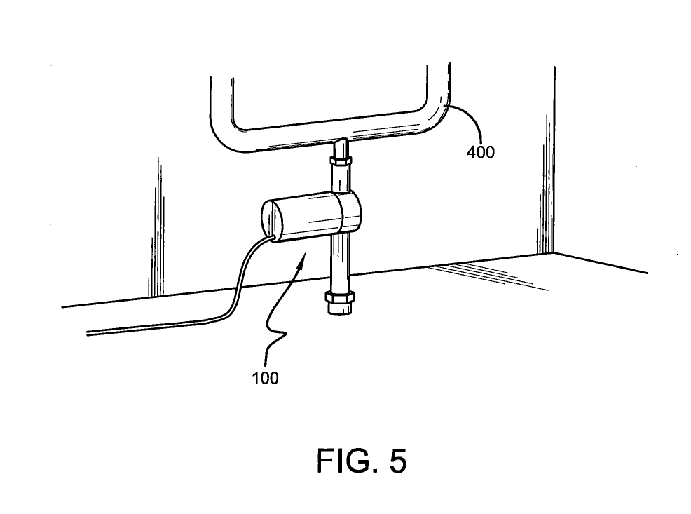

FIGS. 4 and 5 illustrate the in-line generator device 100 in use and affixed to drainage pipes 400 and gas lines 400. In operation, a user (not shown) would select an in-line generator device 100 of a specific size depending on the wants and needs of the user. A user would then secure the in-line generator device 100 to a pipe, drainage pipe, gas line 400, etc., or any other suitable conduit. Specifically, the user would align the in-line generator device 100 in a straight line with the conduit and would secure the device 100 to the conduit via securing the inlet connection and the outlet connection to the conduit 400. For example, the inlet connection and outlet connection are typically secured to the conduit 400 to form the fluid passage via hose clamps, compression clamps, soldering, etc., or any other suitable securing means as is known in the art.

Thus, the in-line generator device 100 can be easily installed into existing plumbing or drainage pipes of a building, hybrid automobile water pump cooling systems, gas and propane lines, pool filtration systems, and municipalities water mains, or any other incoming fluid supply via pressurized pipes and hoses as is known in the art, such that when the fluid is turned on for use, the flow of the fluid through the fluid passage generates power.

Once installed into the conduit 400, fluid is allowed to flow through the device 100. Therefore, the fluid that enters the housing unit through the inlet connection, contacts the paddles of the wheel rotating the wheel, flows through the housing unit, and then expels out the outlet connection of the housing unit. The wheel is positioned tightly within the interior of the housing unit, such that fluid is forced to pass through the bottom of the paddles of the wheel.

Additionally, a drive shaft is secured to the center of rotation of the wheel, and protrudes out through an air tight seal from the wheel to communicate with a generator. The drive shaft is typically formed integrally with the wheel and coaxial with the wheel. Therefore, rotation of the wheel via the flow of fluid through the housing unit, causes rotation of the drive shaft which communicates with the generator to generate electricity. The electricity can then be used directly as its created, or it can be grid-based and sold back to the power company. Any additional or excess electricity that is produced can also be stored in a battery for future use

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An in-line generator device comprising:
a housing unit further comprised of a passage in fluid communication with a conduit;
a wheel secured to the housing unit and in fluid communication with said passage, wherein said wheel further comprises at least one paddle;
a drive shaft secured to the wheel; and
a generator in communication with the drive shaft for generating electricity.

2. The in-line generator device of claim 1, wherein the wheel is positioned at the passage and rotates with passing of a fluid over the at least one paddle of the wheel.

3. The in-line generator device of claim 2, wherein the housing unit further comprises an inlet and an outlet connection which allows the fluid to enter and exit the housing unit.

4. The in-line generator device of claim 3, wherein the inlet and the outlet connections are placed in a straight line, such that the fluid will enter the housing unit through the inlet connection, pass through the wheel, and then exit the housing unit through the outlet connection.

5. The in-line generator device of claim 4, wherein the inlet and the outlet connections are connected to an incoming fluid supply of a building.

6. The in-line generator device of claim 5, wherein the conduit is a pressurized water pipe.

7. The in-line generator device of claim 5, wherein the conduit is a pressurized gas pipe.

8. The in-line generator device of claim 1, wherein the generator is a permanent magnetic alternator (PMA).

9. The in-line generator device of claim 1, further comprising an inverter for converting the electricity to another form of power.

10. The in-line generator device of claim 1, further comprising a battery for storing excess electricity.

11. An in-line generator device, comprising:
a housing unit secured to a pressurized conduit via an inlet and an outlet connection and comprising a passage;
a wheel encased in the housing unit and comprising paddles;
a drive shaft secured to center of rotation of the wheel and protruding outwardly from said wheel; and
a generator in communication with the drive shaft for generating electricity; and
wherein the inlet and the outlet connections allow a fluid to enter and exit the housing unit.

12. The in-line generator device of claim 11, wherein the inlet and the outlet connections are connected to an incoming pressurized fluid supply of a building.

13. The in-line generator device of claim 12, wherein the wheel is positioned at the passage and rotates with passing of a fluid over the paddles of the wheel.

14. The in-line generator device of claim 13, wherein the wheel is positioned tightly within the interior of the housing unit, such that a fluid traveling in the conduit is forced to pass through the paddles of the wheel.

15. The in-line generator device of claim 11, further comprising an inverter for converting the electricity to another form of power.

16. The in-line generator device of claim 11, further comprising a battery for storing excess electricity.

17. The in-line generator device of claim 11, wherein the conduit is a pressurized water pipe.

18. The in-line generator device of claim 11, wherein the conduit is a pressurized gas pipe.

19. An in-line generator device, comprising:
a housing unit secured to a pressurized conduit via an inlet and an outlet connection and comprising a passage;
a wheel encased in the housing unit and comprising paddles;
a drive shaft secured to center of rotation of the wheel and protruding outwardly from the wheel; and
a generator in communication with the drive shaft for generating electricity; and
wherein the inlet and the outlet connections are placed in a straight line, such that the fluid traveling through said pressurized conduit will enter the housing unit through the inlet connection, pass through the wheel, and then exit the housing unit through the outlet connection.

20. The in-line generator device of claim 19, wherein the wheel is positioned tightly within the interior of the housing unit, such that a fluid traveling in said conduit is forced to pass through the paddles of the wheel.
